(19) United States
(12) Patent Application Publication
(10) Pub. No.: US 2025/0227654 A1
(43) Pub. Date: Jul. 10, 2025

(54) METHODS AND APPARATUSES FOR USER EQUIPMENT POSITIONING

(71) Applicant: LENOVO (BEIJING) LIMITED, Beijing (CN)

(72) Inventors: Jie HU, Beijing (CN); Haiming WANG, Beijing (CN); Lianhai WU, Beijing (CN); Ran YUE, Beijing (CN); Lihua YANG, Beijing (CN)

(21) Appl. No.: 18/879,562

(22) PCT Filed: Jun. 30, 2022
(86) PCT No.: PCT/CN2022/102937

§ 371 Date: Dec. 27, 2024

(51) Int. Cl. H04W 64/00; H04W 8/22; H04W 36/08; H04W 76/20

(52) U.S. Cl. CPC H04W 64/00; H04W 8/22; H04W 36/08; H04W 76/20

(57) ABSTRACT

Embodiments of the present application are related to methods and apparatuses for user equipment (UE) positioning. An embodiment of the present application provides a UE including: a transceiver configured to receive first positioning assistance data for downlink (DL) positioning in a radio resource control (RRC) idle state; and a processor coupled to the transceiver and configured to perform DL positioning in the RRC idle state.

### TECHNICAL FIELD

The present disclosure generally relates to wireless communications, and especially to user equipment (UE) positioning.

### BACKGROUND OF THE INVENTION

Downlink (DL) positioning measurement (e.g., DL positioning reference signal (PRS) measurement) is supported in current wireless technology. For UEs in a radio resource control (RRC) connected state or an RRC inactive sate, detailed positioning procedures (including, e.g., procedures for positioning capability transfer or positioning assistance data delivery) have been developed or proposed. However, details of positioning procedures for UEs in an RRC idle state have not been discussed yet.

### SUMMARY

Some embodiments of the present disclosure provide a UE including: a transceiver configured to receive first positioning assistance data for DL positioning in an RRC idle state; and a processor coupled to the transceiver and configured to perform DL positioning in the RRC idle state.

In some embodiments, the transceiver is further configured to: receive a request for positioning capability information when the UE is in the RRC idle state; and transmit the positioning capability information in response to the request, wherein the positioning capability information indicates at least that the UE supports DL positioning in the RRC idle state.

In some embodiments, the request is received in a paging message.

In some embodiments, the positioning capability information is transmitted via a random access channel (RACH) message, an RRC connection setup request message, or a long term evolution (LTE) positioning protocol (LPP) signaling.

In some embodiments, the positioning capability information is transmitted via Msg 3, and the transceiver is further configured to transmit an early indication in Msg 1 by a configured preamble sequence to indicate that the UE supports DL positioning in the RRC idle state.

In some embodiments, the positioning capability information includes at least one of: a first field indicating whether the UE supports DL PRS processing in the RRC idle state; or a second field indicating whether the UE supports DL PRS measurement in the RRC idle state.

In some embodiments, the first positioning assistance data is received in positioning system information when the UE is in the RRC idle state.

In some embodiments, the first positioning assistance data is received when the UE is in an RRC connected state.

In some embodiments, the transceiver is further configured to: transmit an on-demand PRS request in the RRC idle state for requesting PRS configuration for DL positioning in the RRC idle state when the first positioning assistance data does not contain information the UE needs for DL positioning.

In some embodiments, the on-demand PRS request is transmitted via a physical random access channel (PRACH) preamble and/or PRACH resource(s).

In some embodiments, the on-demand PRS request indicates a configured index associated with the requested PRS configuration in Msg 1 or Msg A.

In some embodiments, the Msg 1 or Msg A includes a configured PRACH preamble associated with the requested PRS configuration.

In some embodiments, the on-demand PRS request explicitly indicates parameters for the requested PRS configuration in Msg 3 or Msg A.

In some embodiments, the first positioning assistance data is received in an RRC message or LPP message.

In some embodiments, the processor is further configured to activate the first positioning assistance data when the UE enters the RRC idle state, and de-activate the first positioning assistance data when the UE transitions from the RRC idle state to the RRC connected state and second positioning assistance data for DL positioning in the RRC connected state is acquired.

In some embodiments, the transceiver is further configured to receive at least one validity condition associated with the first positioning assistance data.

In some embodiments, the at least one validity condition is received along with the first positioning assistance data.

In some embodiments, the at least one validity condition includes a validity area.

In some embodiments, the at least one validity condition includes a validity timer, and the processor is further configured to start the validity timer upon the first positioning assistance data being received or upon the UE entering the RRC idle state.

In some embodiments, in the case that one or more validity conditions are configured for the first positioning assistance data, the processor is further configured to continue to use the first positioning assistance data when the UE transitions from the RRC idle state to an RRC connected state, until second positioning assistance data for DL positioning in the RRC connected state is received or at least one validity condition of the one or more validity conditions is not fulfilled.

In some embodiments, in the case that no validity condition is configured for the first positioning assistance data, the transceiver is further configured to transmit a request for positioning assistance data for DL positioning in an RRC connected state when the UE transitions from the RRC idle state to the RRC connected state.

In some embodiments, the processor is further configured to continue to use the first positioning assistance data when the UE transitions from the RRC idle state to an RRC inactive state.

In some embodiments, in the case that one or more validity conditions are configured for the first positioning assistance data, the processor is further configured to continue to use the first positioning assistance data when the UE transitions from the RRC idle state to an RRC inactive state, until at least one validity condition of the one or more validity conditions is not fulfilled.

In some embodiments, the processor is further configured to continue to use third positioning assistance data configured for an RRC connected state when the UE transitions from the RRC connected state to the RRC idle state in the case that an indication indicating to continue to use the third positioning assistance data is received.

In some embodiments, in the case that one or more validity conditions are configured for third positioning assistance data for an RRC connected state, the processor is further configured to continue to use the third positioning assistance data when the UE transitions from the RRC connected state to the RRC idle state, until at least one validity condition of the one or more validity conditions is not fulfilled or fourth positioning assistance data for DL positioning in the RRC idle state is received.

In some embodiments, the processor is further configured to continue to use fifth positioning assistance data configured for an RRC inactive state when the UE transitions from the RRC inactive state to the RRC idle state.

In some embodiments, in the case that one or more validity conditions are configured for fifth positioning assistance data for an RRC inactive state, the processor is further configured to continue to use the fifth positioning assistance data when the UE transitions from the RRC inactive state to the RRC idle state, until at least one validity condition of the one or more validity conditions is not fulfilled.

In some embodiments, the transceiver is further configured to receive positioning specific cell selection or reselection information for use during cell selection or reselection in the RRC idle state.

In some embodiments, the positioning specific cell selection or reselection information includes cell(s) associated with at least one of: a currently serving location management function (LMF); or an area where the first positioning assistance data is valid.

In some embodiments, the processor is further configured to prioritize the cell(s) included in the positioning specific cell selection or reselection information when performing cell selection or reselection in the RRC idle state.

In some embodiments, the positioning specific cell selection or reselection information is received along with or independently of the first positioning assistance data in a system information block (SIB) message or an RRC message.

Some embodiments of the present disclosure provide a network entity including: a transceiver configured to transmit first positioning assistance data for assisting a UE to perform DL positioning in an RRC idle state; and a processor coupled to the transceiver.

In some embodiments, the transceiver is further configured to: transmit, to the UE, a request for positioning capability information when the UE is in the RRC idle state; and receive the positioning capability information from the UE in response to the request, wherein the positioning capability information indicates that the UE supports DL positioning in the RRC idle state.

In some embodiments, the request is transmitted via a paging message.

In some embodiments, the positioning capability information is received in a random access channel message, an RRC connection setup request message, or an LPP signaling.

In some embodiments, the positioning capability information is received in Msg 3, and the transceiver is further configured to receive an early indication in Msg 1 by a configured preamble sequence to indicate that the UE supports DL positioning in the RRC idle state.

In some embodiments, the positioning capability information includes at least one of: a first field indicating whether the UE supports DL PRS processing in the RRC idle state; or a second field indicating whether the UE supports DL PRS measurement in the RRC idle state.

In some embodiments, the first positioning assistance data is transmitted via positioning system information when the UE is in the RRC idle state.

In some embodiments, the first positioning assistance data is transmitted when the UE is in an RRC connected state.

In some embodiments, the transceiver is further configured to: receive, from the UE, an on-demand PRS request for requesting PRS configuration for DL positioning in the RRC idle state when the UE is in the RRC idle state.

In some embodiments, the on-demand PRS request is received via a PRACH preamble and/or PRACH resource(s).

In some embodiments, the on-demand PRS request indicates a configured index associated with the requested PRS configuration in Msg 1 or Msg A.

In some embodiments, the Msg 1 or Msg A includes a configured PRACH preamble associated with the requested PRS configuration.

In some embodiments, the on-demand PRS request explicitly indicates parameters for the requested PRS configuration in Msg 3 or Msg A.

In some embodiments, the processor is further configured to determine a mapping relationship between PRACH preamble(s) and DL PRS configuration(s).

In some embodiments, the first positioning assistance data is transmitted via an RRC message or LPP message.

In some embodiments, the transceiver is further configured to transmit at least one validity condition associated with the first positioning assistance data.

In some embodiments, the at least one validity condition is transmitted along with the first positioning assistance data.

In some embodiments, the at least one validity condition includes at least one of a validity area or a validity timer.

In some embodiments, the transceiver is further configured to transmit an indication indicating the UE to continue to use second positioning assistance data for the RRC connected state when the UE transitions from the RRC connected state to the RRC idle state.

In some embodiments, the indication is transmitted in an RRC connection release message.

In some embodiments, the transceiver is further configured to transmit positioning specific cell selection or reselection information for the UE to use during cell selection or reselection in the RRC idle state.

In some embodiments, the positioning specific cell selection or reselection information includes cell(s) associated with at least one of: a currently serving LMF; or an area where the first positioning assistance data is valid.

In some embodiments, the positioning specific cell selection or reselection information is transmitted along with or independently of the first positioning assistance data in a SIB message or an RRC message.

Some embodiments of the present disclosure provide a method performed by a UE. The method includes: receiving first positioning assistance data for DL positioning in an RRC idle state; and performing DL positioning in the RRC idle state.

Some embodiments of the present disclosure provide a method performed by a network entity. The method includes transmitting first positioning assistance data for assisting a UE to perform DL positioning in an RRC idle state.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present disclosure.

FIG. 2 illustrates a flowchart of an exemplary method performed by a UE according to some embodiments of the present disclosure.

FIG. 3 illustrates a flowchart of an exemplary method for DL positioning according to some embodiments of the present disclosure.

FIG. 4 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G new radio (NR), 3GPP LTE, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

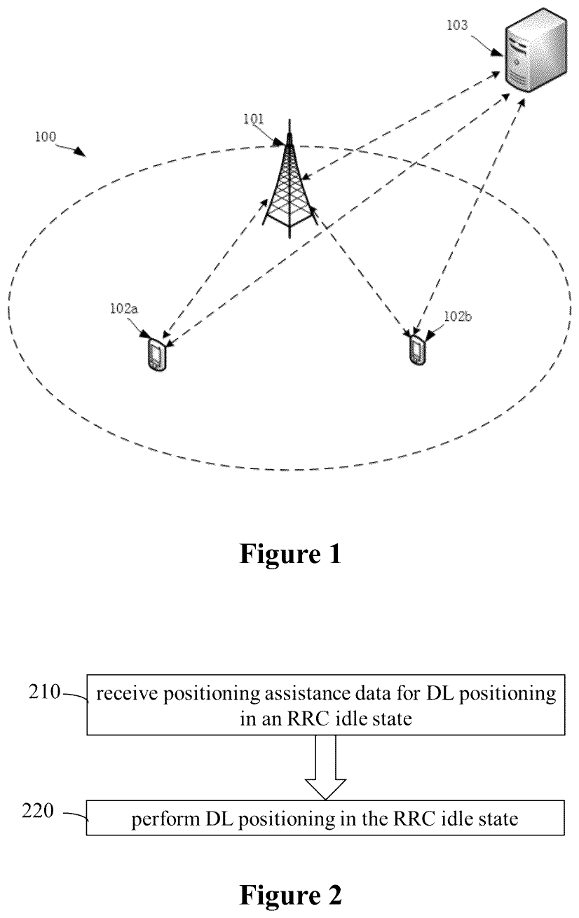

FIG. 1 is a schematic diagram illustrating an exemplary wireless communication system 100 according to some embodiments of the present disclosure.

As shown in FIG. 1, the wireless communication system 100 includes at least one base station (BS) 101, at least one UE (e.g., a UE 102a and a UE 102b), and at least one LMF 103. Although one BS, two UEs, and one LMF are depicted in FIG. 1 for illustrative purpose, it is contemplated that any number of BSs, UEs, and LMFs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a radio access network (RAN) node, a next generation (NG) RAN node, a node-B, an enhanced node B (eNB), a gNB, a home node-B, a relay node, or a device, or described using other terminology used in the art. The BS 101 is generally part of a RAN that may include a controller communicably coupled to the BS 101.

According to some embodiments of the present application, the UE 102a and the UE 102b may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

According to some other embodiments of the present application, the UE 102a and the UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a and the UE 102b may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a and the UE 102b may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the example of FIG. 1 are in a coverage area of the BS 101, and may communicate with the BS 101, for example, via LTE or NR Uu interface.

The LMF 103 (also referred to as LMF entity) may refer to a network element or network entity for supporting location services, which may be deployed in a core network (CN) or in a RAN of the wireless communication system 100. The LMF 103 may communicate with the BS 101 via NR positioning protocol A (NRPPa) signaling, and may communicate with the UE 102a or UE 102b via LPP signaling. In the present disclosure, both LMF and BS may be referred to as a network entity or the network.

For a UE in an RRC connected state, a connection is established between the UE and a BS, and a connection is also established between the UE and an LMF. For a UE in an RRC inactive state, a connection is established between the UE and an LMF, whereas no connection is established between the UE and a BS. For a UE in an RRC idle state, no connection is established between the UE and a BS or an LMF.

DL positioning can be performed by UEs in the RRC connected state or RRC inactive sate. For example, when a UE is in the RRC inactive state, if the UE initiated data transmission using uplink (UL) small data transmission (SDT), the network can send DL location service (LCS), LPP and RRC messages (e.g., to configure positioning reference signal (PRS) for DL positioning, if it is supported) to the UE, and the UE may perform DL positioning accordingly; otherwise, if the UE did not initiate UL SDT, the network may transition the UE to the RRC connected state, e.g., based on RAN paging, and the UE may perform DL positioning in the RRC connected state.

Positioning assistance data may be delivered from the network to the UE to help the UE perform PRS reception and measurement when DL positioning methods are applied. For example, for DL positioning in the RRC inactive state, the positioning assistance data can be delivered to the UE through positioning system information, by configuring positioning assistance data when the UE is in the RRC connected state, or by sending positioning assistance data during an ongoing SDT procedure, etc.

UEs may also support DL positioning in the RRC idle state. The present disclosure focuses on implementing DL positioning (e.g., DL PRS measurement) for UEs in the RRC idle state, including the details of procedures for positioning capability transfer, positioning assistance data delivery, etc.

FIG. 2 illustrates an exemplary method performed by a UE supporting DL positioning in the RRC idle state according to some embodiments of the present disclosure.

In step 210, the UE may receive positioning assistance data for DL positioning in the RRC idle state from a network.

According to some embodiments of the present disclosure, the UE may receive the positioning assistance data for DL positioning in the RRC idle state when the UE is in the RRC idle state. For example, the UE may receive the positioning assistance data via positioning system information (e.g., posSIB).

According to some embodiments of the present disclosure, the UE may receive the positioning assistance data for DL positioning in the RRC idle state when the UE is in the RRC connected state. In some embodiments, the UE may receive the positioning assistance data in an RRC message from a BS or an LPP message from an LMF. For example, the RRC message may be an RRC connection release message, or a separate RRC message. In some embodiments of the present disclosure, the UE may activate the positioning assistance data when the UE enters the RRC idle state, for example, upon reception of an RRC connection release message from the BS, and de-activate the positioning assistance data when the UE transitions from the RRC idle state to the RRC connected state and new positioning assistance data for DL positioning in the RRC connected state is acquired from the network, e.g., by an LPP or RRC message.

According to some embodiments, in the case that the received positioning assistance data for DL positioning in the RRC idle state does not contain information (e.g., sufficient information) the UE needs for performing DL positioning in the RRC idle state, the UE in the RRC idle state may transmit an on-demand PRS request for requesting PRS configuration for DL positioning in the RRC idle state. In some embodiments, the on-demand PRS request may be transmitted via a PRACH preamble and/or PRACH resource(s).

In some embodiments of the present disclosure, the network may determine a mapping relationship between PRACH preamble(s) and PRS configuration(s) for DL positioning. For example, the LMF may negotiate with the BS to configure the mapping relationship between PRACH preamble(s) and corresponding PRS configuration(s) (e.g., index(es) of the corresponding PRS configuration(s)). Accordingly, the on-demand PRS request may indicate a configured index associated with the requested PRS configuration in Msg 1 (for 4-step RACH) or Msg A (for 2-step RACH). For example, the Msg 1 or Msg A may include a configured PRACH preamble associated with the requested PRS configuration according to the mapping relationship determined by the network. For example, one specific PRACH preamble is associated with posSibType6-6 (NR-On-Demand-DL-PRS-Configurations). Upon reception of such PRACH preamble, the network may know the corresponding PRS configuration needed by the UE.

In some embodiments of the present disclosure, the on-demand PRS request may explicitly indicate parameters for the requested PRS configuration in Msg 3 (for 4-step RACH) or Msg A (for 2-step RACH).

In step 220, the UE may perform DL positioning (e.g., DL PRS measurement) in the RRC idle state. The positioning assistance data received in step 210 may be used in the DL positioning. In some embodiments, after performing DL positioning in the RRC idle state, the UE may report DL positioning measurement and/or positioning estimation to the network.

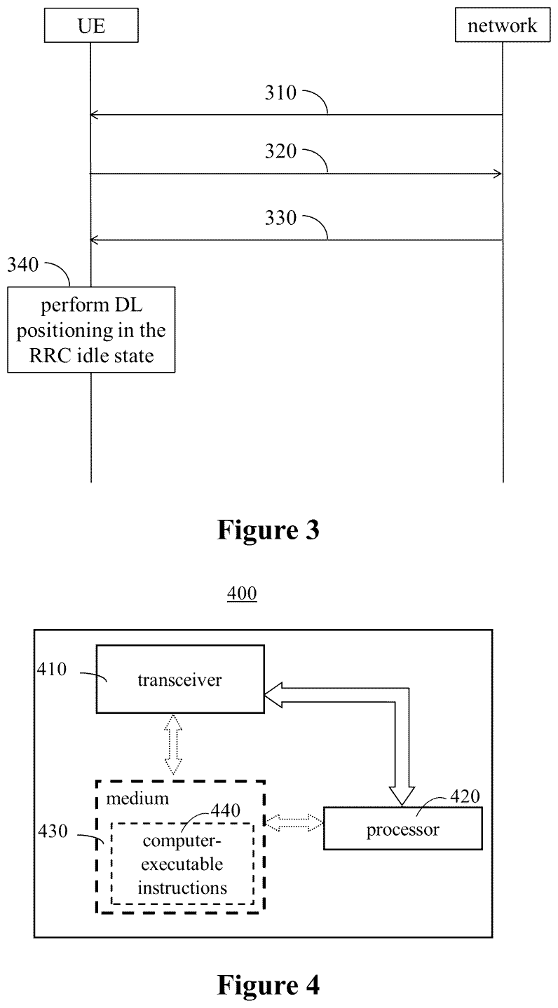

FIG. 3 illustrates an exemplary method for DL positioning according to some embodiments of the present disclosure. The method includes interactions between a UE and a network.

In step 310, the network may transmit a request for positioning capability information to the UE when the UE is in the RRC idle state.

In some embodiments, the request for positioning capability information is included in a request message from an access and mobility management function (AMF) to a BS, and the BS transmits the request for positioning capability information via e.g., a paging message to the UE. In some embodiments, the paging message may be a core network (CN) paging message.

In step 320, the UE may transmit its positioning capability information to the network in response to the request received from the network, wherein the positioning capability information may indicate that the UE supports DL positioning in the RRC idle state.

In some embodiments, the UE may transmit the positioning capability information via a random access channel message (e.g., Msg 3 or Msg A) or an RRC connection setup request message after receiving the paging message. For example, if 4-step RACH is applied, the UE indicates the positioning capability information to the network in Msg 3; if 2-step RACH is applied, the UE may transmit the positioning capability information to the network in Msg A. In some embodiments, the UE may transmit the positioning capability information via an LPP signaling after the UE enters the RRC connected state by a RACH procedure.

In some embodiments, a specific preamble sequence associated with positioning is configured. In such cases, the UE may transmit an early indication in Msg 1 by the configured preamble sequence to indicate that the UE supports DL positioning in the RRC idle state, and then transmit the positioning capability information in Msg 3. The use of the early indication may expedite signal processing and improve efficiency.

In some embodiments, the positioning capability information may indicate one or more capabilities related to DL positioning. For example, the positioning capability information may include at least one of:
a first field (e.g., nr-DL-PRS-ProcessingRRC-Idle) indicating whether the UE supports DL PRS processing in the RRC idle state; or
a second field (e.g., nr-dl-PRS-MeasRRC-Idle) indicating whether the UE supports DL PRS measurement in the RRC idle state.

In some embodiments, the UE in the RRC idle state transmits the positioning capability information to the BS, and the BS forwards the positioning capability information to the LMF.

In some embodiments, in the case that the UE does not support DL positioning in the RRC idle state, the UE may transmit positioning capability information indicating that the UE does not support DL positioning in the RRC idle state in response to the request received from the network.

In some embodiments, after the network transmits the request for positioning capability information to a UE in the RRC idle state, if the UE does not initiate a RACH procedure or the UE does not transmit positioning capability information to the network, the network may assume that the UE does not support DL positioning in the RRC idle state.

After receiving the positioning capability information indicating that the UE supports DL positioning in the RRC idle state, in step 330, the network may transmit positioning assistance data for DL positioning in the RRC idle state to the UE. In some embodiments, the UE may transmit a request message to indicate that it is interested in being configured with positioning assistance data for DL Positioning in the RRC idle state; after receiving the positioning capability information indicating that the UE supports DL positioning in the RRC idle state and also receiving the request message from the UE to indicate that it is interested in being configured with positioning assistance data for DL Positioning in the RRC idle state, in step 330, the network may transmit positioning assistance date for DL positioning in the RRC idle state to the UE. For example, the positioning assistance data may be transmitted to the UE in the manner as described with respect to FIG. 2.

In step 340, the UE may perform DL positioning in the RRC idle state. In some embodiments, after performing DL positioning in the RRC idle state, the UE may report DL positioning measurement and/or positioning estimation to the network.

In some embodiments, the UE may receive one or more validity conditions associated with the positioning assistance data for DL positioning in the RRC idle state (i.e., the one or more validity conditions are configured for the positioning assistance data). For example, one or more validity conditions may be received along with the associated positioning assistance data. In this case, the positioning assistance data for DL positioning in the RRC idle state is valid only when the one or more validity conditions are fulfilled.

In some embodiments of the present disclosure, the one or more validity conditions may include a validity area, wherein the positioning assistance data is valid only when the UE is within the validity area. The validity area may include one or more cell, a tracking area, etc.

In some embodiments of the present disclosure, the one or more validity conditions may include valid time information, e.g., a validity timer. The UE may start the validity timer upon the positioning assistance data being received or upon the UE entering the RRC idle state, for example, upon receiving an RRC connection release message from the BS. The positioning assistance data is valid only after the timer is started and before the timer expires.

In some embodiments of the present disclosure, in the case that one or more validity conditions are configured for the positioning assistance data for DL positioning in the RRC idle state, the UE may continue to use the positioning assistance data for DL positioning in the RRC idle state when the UE transitions from the RRC idle state to the RRC connected state, until the UE receives other positioning assistance data for DL positioning in the RRC connected state (for example, the UE may receive new positioning assistance data via an LPP message, e.g., provideassistancedata, in the RRC connected state) or at least one validity condition of the one or more validity conditions is not fulfilled.

In some embodiments of the present disclosure, in the case that no validity condition is configured for the positioning assistance data for DL positioning in the RRC idle state, the UE may transmit a request (e.g., RequestAssistancedata) for positioning assistance data for DL positioning in the RRC connected state when the UE transitions from the RRC idle state to the RRC connected state.

In some embodiments of the present disclosure, in the case that no validity condition is configured for the positioning assistance data for DL positioning in the RRC idle state, the UE may continue to use the positioning assistance data for DL positioning in the RRC idle state when the UE transitions from the RRC idle state to the RRC inactive state.

In some embodiments of the present disclosure, in the case that one or more validity conditions are configured for the positioning assistance data for DL positioning in the RRC idle state, the UE may continue to use the positioning assistance data for DL positioning in the RRC idle state when the UE transitions from the RRC idle state to the RRC inactive state, until at least one validity condition of the one or more validity conditions is not fulfilled or the UE receives other positioning assistance data for DL positioning in the RRC inactive state (for example, the UE may receive new positioning assistance data from a SIB message, or from an ongoing SDT procedure in the RRC inactive state).

In some embodiments of the present disclosure, the UE may continue to use positioning assistance data for DL positioning in the RRC connected state when the UE transitions from the RRC connected state to the RRC idle state in the case that the UE receives from the network an indication indicating to continue to use the positioning assistance data for DL positioning in the RRC connected state. For example, the UE may receive the indication in an RRC connection release message.

In some embodiments of the present disclosure, in the case that one or more validity conditions (e.g., a validity area or a validity timer) are configured for the positioning assistance data for DL positioning in the RRC connected state, the UE may continue to use the positioning assistance data for DL positioning in the RRC connected state when the UE transitions from the RRC connected state to the RRC idle state, until at least one validity condition of the one or more validity conditions is not fulfilled or the UE receives other positioning assistance data for DL positioning in the RRC idle state (for example, the UE may receive new positioning assistance data from a SIB message in the RRC idle state).

In some embodiments of the present disclosure, in the case that no validity condition is configured for the positioning assistance data for DL positioning in the RRC inactive state, the UE may continue to use positioning assistance data for DL positioning in the RRC inactive state when the UE transitions from the RRC inactive state to the RRC idle state.

In some embodiments of the present disclosure, in the case that one or more validity conditions (e.g., a validity area or a validity timer) are configured for the positioning assistance data for DL positioning in the RRC inactive state, the UE may continue to use the positioning assistance data for DL positioning in the RRC inactive state when the UE transitions from the RRC inactive state to the RRC idle state, until at least one validity condition of the one or more validity conditions is not fulfilled or the UE receives other positioning assistance data for DL positioning the RRC idle sate (for example, the UE may receive new positioning assistance data from a SIB message in the RRC idle state).

In some embodiments of the present disclosure, in the case that one or more validity conditions are configured for the positioning assistance data for DL positioning in the RRC inactive state, the UE may continue to use the positioning assistance data for DL positioning in the RRC inactive state when the UE transitions from the RRC inactive state to the RRC connected state, until the UE receives other positioning assistance data for DL positioning in the RRC connected state (for example, the UE may receive new positioning assistance data via an LPP message, e.g., provideassistancedata, in the RRC connected state) or at least one validity condition of the one or more validity conditions is not fulfilled.

In some embodiments of the present disclosure, in the case that no validity condition is configured for the positioning assistance data for DL positioning in the RRC inactive state, the UE may transmit a request (e.g., RequestAssistancedata) for positioning assistance data for DL positioning in the RRC connected state when the UE transitions from the RRC inactive state to the RRC connected state.

In some embodiments of the present disclosure, the UE may continue to use positioning assistance data for DL positioning in the RRC connected state when the UE transitions from the RRC connected state to the RRC inactive state in the case that the UE receives an indication indicating to continue to use the positioning assistance data for DL positioning in the RRC connected state. For example, the UE may receive the indication in an RRC connection release message.

In some embodiments of the present disclosure, in the case that one or more validity conditions (e.g., a validity area or a validity timer) are configured for the positioning assistance data for DL positioning in the RRC connected state, the UE may continue to use the positioning assistance data for DL positioning in the RRC connected state when the UE transitions from the RRC connected state to the RRC inactive state, until at least one validity condition of the one or more validity conditions is not fulfilled or the UE receives other positioning assistance data for DL positioning in the RRC inactive state (for example, the UE may receive new positioning assistance data from a SIB message, or from an ongoing SDT procedure in the RRC inactive state).

In some embodiments of the present disclosure, the network may transmit positioning specific cell selection or reselection information to the UE, which may be used during cell selection or reselection in the RRC idle state. In some embodiments, the positioning specific cell selection or reselection information includes cell(s) associated with at least one of:
a currently serving LMF; or
an area where the positioning assistance data for DL positioning in the RRC idle state is valid.

In the present disclosure, the cell may refer to a cell of a BS, a transmit-receive point (TRP), or a BS.

In some embodiments, the network may transmit the positioning specific cell selection or reselection information along with or independently of the positioning assistance data for DL positioning in the RRC idle state. For example, the positioning specific cell selection or reselection information may be transmitted in a SIB message or an RRC message (e.g., an RRC connection release message).

According to some embodiments of the present disclosure, the UE may prioritize the cell(s) included in the positioning specific cell selection or reselection information when performing cell selection or reselection in the RRC idle state. That is, the cell(s) included in the positioning specific cell selection or reselection information may have a higher priority to be selected or reselected than other candidate cell(s) not included in the positioning specific cell selection or reselection information. The use of the positioning specific cell selection or reselection information may save signaling overhead and improve efficiency for DL positioning.

FIG. 4 illustrates a simplified block diagram of an exemplary apparatus 400 according to some embodiments of the present disclosure.

In some embodiments, the apparatus 400 may be or include at least part of a UE which is capable of performing the aforementioned methods for DL positioning in the RRC idle state.

In some embodiments, the apparatus 400 may be or include at least part of a network entity which is capable of performing the aforementioned methods for DL positioning from the network side.

As shown in FIG. 4, the apparatus 400 may include at least a transceiver 410 and a processor 420 coupled to transceiver 410. In some embodiments, the transceiver 410 may include a transmitter and a receiver integrated together. In some embodiments, the transceiver 410 may include a transmitter and a receiver which are separated from each other. In some embodiments, the transceiver 410 may be a wireless transceiver.

In some embodiments, the apparatus 400 may include a non-transitory computer-readable medium 430 with computer-executable instructions 440 stored thereon, wherein the non-transitory computer-readable medium 430 may be coupled to the processor 420 and the transceiver 410, and the computer-executable instructions 440 may be configured to be executable by the processor 420. In some embodiments, the transceiver 410, the non-transitory computer-readable medium 430, and the processor 420 may be coupled to each other via one or more local buses.

Although in FIG. 4, elements such as the transceiver 410, the non-transitory computer-readable medium 430, and the processor 420 are described in the singular, the plural is contemplated unless limitation to the singular is explicitly stated. In certain embodiments of the present disclosure, the apparatus 400 may further include other components for actual usage.

In various example embodiments, the processor 420 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 420 may also include at least one other circuitry or element not shown in FIG. 4.

In various example embodiments, the non-transitory computer-readable medium 430 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, the non-transitory computer-readable medium 430 may include, but is not limited to, an electric, a magnetic, an optical, an electromagnetic, an infrared, or a semiconductor system, apparatus, or device or any combination of the above.

Further, in various example embodiments, the apparatus 400 may also include at least one other circuitry, element, and interface, for example antenna element, and the like.

According to some embodiments, the apparatus 400 is a UE. The transceiver 410 and the processor 420 may be configured to perform operations in any methods described above which are performed by a UE. For example, the transceiver 410 may be configured to receive positioning assistance data for DL positioning in an RRC idle state, and the processor 420 may be configured to perform DL positioning in the RRC idle state.

According to some embodiments, the apparatus 400 is a network entity. The transceiver 410 and the processor 420 may be configured to perform operations in any methods described above which are performed by a network entity. For example, the transceiver 410 may be configured to transmit positioning assistance data for assisting a UE to perform DL positioning in an RRC idle state.

In various example embodiments, the circuitry, parts, elements, and interfaces in exemplary apparatus, including processor and non-transitory computer-readable medium, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configured to cause the UE to:
receive first positioning assistance data for downlink (DL) positioning in a radio resource control (RRC) idle state; and
perform DL positioning in the RRC idle state.

2. The UE of claim 1, wherein the at least one processor is further configured to cause the UE to:
receive a request for positioning capability information when the UE is in the RRC idle state; and
transmit the positioning capability information in response to the request, wherein the positioning capability information indicates that the UE supports DL positioning in the RRC idle state, and wherein the request is received in a paging message.

3. The UE of claim 2, wherein the positioning capability information is transmitted via Msg 3, and wherein the at the at least one processor is further configured to cause the UE to transmit an early indication in Msg 1 by a configured preamble sequence to indicate that the UE supports DL positioning in the RRC idle state.

4. The UE of claim 1, wherein the at least one processor is further configured to cause the UE to:
transmit an on-demand PRS request in the RRC idle state for requesting PRS configuration for DL positioning in the RRC idle state when the first positioning assistance data does not contain information the UE needs for DL positioning, wherein the on-demand PRS request is transmitted via a physical random access channel (PRACH) preamble or PRACH resources.

5. The UE of claim 1, wherein the at least one processor is further configured to cause the UE to receive at least one validity condition associated with the first positioning assistance data.

6. The UE of claim 5, wherein the at least one validity condition comprises a validity area.

7. The UE of claim 5, wherein the at least one validity condition comprises a validity timer, and the at least one processor is further configured to cause the UE to start the validity timer upon the first positioning assistance data being received or upon the UE entering the RRC idle state.

8. The UE of claim 1, wherein, when one or more validity conditions are configured for the first positioning assistance data, the at least one processor is further configured to cause the UE to continue to use the first positioning assistance data when the UE transitions from the RRC idle state to an RRC connected state, until second positioning assistance data for DL positioning in the RRC connected state is received or at least one validity condition of the one or more validity conditions is not fulfilled.

9. The UE of claim 1, wherein, when one or more validity conditions are configured for the first positioning assistance data, the at least one processor is further configured to cause the UE to continue to use the first positioning assistance data when the UE transitions from the RRC idle state to an RRC inactive state, until at least one validity condition of the one or more validity conditions is not fulfilled.

10. The UE of claim 1, wherein the at least one processor is further configured to cause the UE to continue to use third positioning assistance data configured for an RRC connected state when the UE transitions from the RRC connected state to the RRC idle state when an indication indicating to continue to use the third positioning assistance data is received.

11. The UE of claim 1, wherein, when one or more validity conditions are configured for third positioning assistance data for an RRC connected state, the at least one processor is further configured to cause the UE to continue to use the third positioning assistance data when the UE transitions from the RRC connected state to the RRC idle state, until at least one validity condition of the one or more validity conditions is not fulfilled or fourth positioning assistance data for DL positioning in the RRC idle state is received.

12. The UE of claim 1, wherein, when one or more validity conditions are configured for fifth positioning assistance data for an RRC inactive state, the at least one processor is further configured to cause the UE to continue to use the fifth positioning assistance data when the UE transitions from the RRC inactive state to the RRC idle state, until at least one validity condition of the one or more validity conditions is not fulfilled.

13. The UE of claim 1, wherein the at least one processor is further configured to cause the UE to receive positioning specific cell selection or reselection information for use during cell selection or reselection in the RRC idle state, and wherein the positioning specific cell selection or reselection information includes cells associated with at least one of:
a currently serving location management function (LMF); or
an area where the first positioning assistance data is valid.

14. The UE of claim 13, wherein the at least one processor is further configured to cause the UE to prioritize the cells included in the positioning specific cell selection or reselection information when performing cell selection or reselection in the RRC idle state.

15. A network entity for wireless communication, comprising:
at least one memory; and
at least one processor coupled with the at least one memory and configured to cause the network entity to:
transmit first positioning assistance data for assisting a user equipment (UE) to perform downlink (DL) positioning in a radio resource control (RRC) idle state.

16. The UE of claim 1, wherein the first positioning assistance data is received in positioning system information when the UE is in the RRC idle state.

17. The UE of claim 1, wherein the at least one processor is further configured to cause the UE to:
receive the first positioning assistance data in an RRC connected state.

18. The UE of claim 1, wherein the at least one processor is configured to receive the first positioning assistance data via an RRC message or an LTE positioning protocol (LPP) message.

19. A processor for wireless communication, comprising:
at least one controller coupled with the at least one memory and configured to cause the processor to:
receive first positioning assistance data for downlink (DL) positioning in a radio resource control (RRC) idle state; and
perform DL positioning in the RRC idle state.

20. A method performed by a user equipment (UE), the method comprising:
receiving first positioning assistance data for downlink (DL) positioning in a radio resource control (RRC) idle state; and
performing DL positioning in the RRC idle state.
